(19) United States
(12) Patent Application Publication
(10) Pub. No.: US 2009/0057401 A1
(43) Pub. Date: Mar. 5, 2009

(54) SYSTEM AND METHODS FOR PROVIDING PREPAID CAR WASH OR LUBE SERVICES

(75) Inventors: Dale R. Brott, Uniontown, OH (US); Steven E. Summers, Uniontown, OH (US)

Correspondence Address: Fay Sharpe LLP, 1228 Euclid Avenue, 5th Floor, The Halle Building, Cleveland, OH, 44115-1843, US

(73) Assignee: DRB Systems, Incorporated, Akron, OH (US)

(21) Appl. No.: 12/201,119

(22) Filed: Aug. 29, 2008

Related U.S. Application Data
(60) Provisional application No. 60/969,388, filed on Aug. 31, 2007.

(51) Int. Cl. G06K 5/00

(52) U.S. Cl. 235/382; 235/380

(57) ABSTRACT

Systems and methods are disclosed for operating an automated vehicle wash or lubrication system and providing user selected car wash or lubrication services according to a prepaid customer account, in which the customer's credit card is automatically charged at a regular interval or based on a certain number of services having been provided for the prepaid wash or lubrication services.

### REFERENCE TO RELATED APPLICATION

This application claims priority to and the benefit of U.S. Provisional Patent Application Ser. No. 60/969,388, filed Aug. 31, 2007, entitled SYSTEM AND METHODS FOR PROVIDING PREPAID CAR WASH OR LUBE SERVICES, the entirety of which is hereby incorporated by reference.

### INCORPORATION BY REFERENCE

Summers et al., U.S. Pat. No. 6,402,030, filed Oct. 23, 2000, assigned to DRB Systems, Inc. of Uniontown, Ohio, is hereby incorporated by reference in its entirety as if fully set forth herein.

### BACKGROUND

The present disclosure relates generally to automated vehicle wash or lube systems, and more particularly to systems and methods for providing prepaid carwash or lube services. Automated car wash systems are found in a variety of forms including stand alone car wash sites and car washes located at gas stations or other commercial businesses. Similarly, lube stations are becoming widely popular, often as stand-alone stations of a multi-site chain. Car wash customers typically select from basic wash services, waxing options, under carriage wash options, and the like, and the services are provided through automated brushes, sprayers, pumps, conveyors, and dryers in a car wash tunnel. The various washing, waxing, and drying apparatus in the tunnel are typically actuated by a control system providing control signals to implement the desired wash services.

The customer may make their wash service selections in a variety of ways, such as by choosing specific services from a menu-driven user interface at which payment for a given wash transaction can be made using a credit card. In other examples, a customer may describe the desired services to an attendant at a point of sale terminal inside a gas station, pay for the car wash, and be given a code for entry into a user interface at the entrance to the car wash tunnel. Alternatively, the customer may interact with an attendant at the wash entrance, select the desired car wash services, exit the vehicle, and pay for the selected services at a point of sale (POS) station while the vehicle is being washed, with the car wash attendant arranging for the selected services to be provided as the vehicle moves through the car wash tunnel. Similarly, lube station services such as oil changes, vehicle lubes, replacement of filters, etc., are typically selected in consultation with a station attendant who explains the available services and costs to the customer before the vehicle enters the lube station, where the customer pays for the services before, during, or after the services are performed.

Such transactional payment situations have become typical of a large number of automated car washes. However, these techniques require that the customer pay for each car wash or lube service individually. Thus, there remains a need for methods and systems that allow car wash or lube station customers to pay for more than one service in advance.

### BRIEF DESCRIPTION

One or more aspects of the invention are now summarized to facilitate a basic understanding of the invention, wherein this summary is not an extensive overview of the invention, and is intended neither to identify certain elements of the invention, nor to delineate the scope thereof. The primary purpose of the summary, rather, is to present some concepts of the invention in a simplified form prior to the more detailed description that is presented hereinafter. The present invention involves systems and methods for providing user selectable car wash and/or vehicle lubrication services in association with a prepaid customer account that allows multiple car washes and/or lubes for a specified customer vehicle in a given time period or a fixed number of wash/lube services over any period of time, without transactional payments being required, and by which the above mentioned problems and shortcomings of conventional transactional payment techniques may be mitigated or overcome.

Various aspects of the disclosure relate to a method for providing prepaid vehicle wash or lubrication services in an automated car wash or lubrication station. The method includes establishing a prepaid customer account for car wash or lubrication services to be provided to a customer vehicle in predefined time periods, where the account specifies a customer credit card as well as customer-selected car wash or lubrication services to be provided to a specific customer vehicle. The account may also include a customer-specified regular interval at which the credit card will be automatically charged, and whether the account allows for unlimited provisions of the specified services or a customer-selected fixed number of services to be provided in each of the predefined time periods. The method further includes providing a tag comprising tag data indicative of the prepaid customer account, and affixing the tag to a specific customer vehicle. In certain implementations, the tag may be an RFID tag, a barcoded tag, or a tag with a magnetic storage medium encoded to indicate the customer account. The tag is preferably affixed to a specific customer vehicle, and is preferably rendered inoperative if attempts are made to remove the tag from the vehicle, so as to inhibit unauthorized use of the tag with multiple vehicles. In further embodiments, the account information may include the customer vehicle's license plate number, with the license plate operating as the vehicle tag, and with the site optically (or manually) reading the license plate to identify the prepaid account. The method also includes reading tag data from the tag when the specific customer vehicle is brought to the car wash or lubrication station, and automatically identifying the prepaid customer account based at least partially on the tag data. In addition, the method includes providing the customer selected carwash or lubrication services to the specific customer vehicle according to the customer account, and automatically charging the customer credit card at the specified regular interval for the services provided under the account during the predefined time periods.

Other aspects of the disclosure provide a method for providing prepaid vehicle wash or lubrication services in an automated car wash or lubrication station, in which a prepaid account is established specifying a customer credit card, customer selected car wash or lubrication services to be provided, and a selected number of wash or lubrication services. In this plan, the customer may obtain the selected number of services over any time period using a tag with data indicative of the account, and the customer credit card is charged to replenish the account once a given number of the customer selected car wash or lubrication services have been provided under the prepaid customer account, where the given number is less than or equal to the selected number.

Further aspects of the disclosure provide an automated vehicle wash or lubrication system that includes a car wash tunnel or lubrication station, a tag reader operative to read tag data from a tag mounted on customer vehicles at the car wash tunnel or lubrication station, and a prepaid account data store that includes prepaid customer account information for one or more customer accounts, where the account information includes a customer credit card and customer-selected car wash or lubrication services to be provided to a customer vehicle during the predefined time periods. The system also includes a site management system operatively coupled with the data store and with the tag reader to identify the customer account from the tag data, as well as a car wash or lubrication station control system operated by the site management system to provide the customer selected carwash or lubrication services to the customer vehicle according to the customer account information, and an automatic charge system operatively coupled with the prepaid account data store to automatically charge the customer credit card at a regular interval. The tag reader, the wash/lube station control system, and the automatic charging system in certain aspects of the disclosure are also operatively coupled with a point of sale (POS) system at the site.

Still other aspects of the disclosure relate to an automated vehicle wash or lubrication system comprising a car wash tunnel or lubrication station, a prepaid account data store, a tag reader, a site management system, a car wash or lubrication station control system, and an automatic charge system, where the prepaid customer account information includes a customer credit card, customer selected car wash or lubrication services to be provided, and a selected number of wash or lubrication services. The charge system is operatively coupled with the prepaid account data store to automatically charge the customer credit card once a given number of the customer selected car wash or lubrication services have been provided under the prepaid customer account, with the given number being less than or equal to the selected number.

The systems, moreover, may operate in a multi-site chain having two or more is 5 sites, where each site includes a car wash tunnel or lubrication station, a tag reader, a site management system, and a car wash or lubrication station control system operated by the site management system to provide the customer selected car wash or lubrication services to the customer vehicle according to the customer account information.

Still further aspects of the disclosure provide methods for operating an automated vehicle wash or lubrication system, in which a prepaid account data store is provided with prepaid customer account information for a customer account. The account information includes a customer credit card and customer selected car wash or lubrication services to be provided to a customer vehicle during predefined time periods. Tag data is read from a tag mounted on a customer vehicle when the customer vehicle is brought to the car wash or lubrication station, and a prepaid customer account is automatically identified based at least partially on the tag data using the prepaid account data store. The method further includes automatically providing the customer selected car wash or lubrication services to the customer vehicle according to the customer account information, and automatically charging the customer credit card at a regular interval for services provided under the prepaid customer account during the predefined time periods.

Further aspects of the disclosure provide a method for operating an automated vehicle wash or lubrication system, which includes providing a prepaid account data store having prepaid customer account information for a customer account that specifies a customer credit card, customer selected car wash or lubrication services to be provided, and a selected number of wash or lubrication services. The method further includes reading tag data from a tag mounted on a customer vehicle when the customer vehicle is brought to the car wash or lubrication station, automatically identifying a prepaid customer account based at least partially on the tag data using the prepaid account data store, automatically providing the customer selected car wash or lubrication services, and automatically charging the customer credit card once a given number of the customer selected car wash or lubrication services have been provided under the prepaid customer account, the given number being less than or equal to the selected number.

In accordance with other aspects of the disclosure, a computer-readable medium is provided, having computer-executable instructions for performing the steps of establishing a prepaid customer account for car wash or lubrication services to be provided to a customer vehicle in predefined time periods, the account specifying a customer credit card as well as customer selected carwash or lubrication services to be provided to the customer vehicle, programming a tag with tag data indicative of the prepaid customer account, reading tag data from the tag when the specific customer vehicle is brought to the car wash or lubrication station, automatically identifying the prepaid customer account based at least partially on the tag data, providing the customer selected car wash or lubrication services to the specific customer vehicle according to the customer account, and automatically charging the customer credit card at a regular interval for services provided under the prepaid customer account during the predefined time periods.

Other aspects of the disclosure a computer-readable medium is provided having computer-executable instructions for providing a prepaid account data store including prepaid customer account information for a customer account, the account specifying a customer credit card, customer selected carwash or lubrication services to be provided, and a selected number of wash or lubrication services, reading tag data from a tag mounted on a customer vehicle when the customer vehicle is brought to the car wash or lubrication station, automatically identifying a prepaid customer account based at least partially on the tag data using the prepaid account data store, automatically providing the customer selected car wash or lubrication services to the customer vehicle according to the customer account information, and automatically charging the customer credit card once a given number of the customer selected car wash or lubrication services have been provided under the prepaid customer account, the given number being less than or equal to the selected number.

### BRIEF DESCRIPTION OF THE DRAWINGS

The present subject matter may take form in various components and arrangements of components, and in various steps and arrangements of steps. The drawings are only for purposes of illustrating preferred embodiments and are not to be construed as limiting the subject matter. The following description and drawings set forth certain illustrative implementations of the invention in detail, which are indicative of several exemplary ways in which the principles of the invention may be carried out. The illustrated examples, however, are not exhaustive of the many possible embodiments of the invention. Other objects, advantages and novel features of the invention will be set forth in the following detailed description of the invention when considered in conjunction with the drawings, in which:

FIG. 1 is a schematic diagram illustrating an exemplary multi-site car wash or vehicle lube system in accordance with one or more aspects of the present disclosure;

FIG. 2 is a schematic diagram illustrating another possible configuration of a multi-site car wash chain according to various aspects of the disclosure;

FIG. 3 is a flow diagram illustrating an exemplary method of operating an automated vehicle wash or lubrication system for supporting unlimited usage plans in accordance with further aspects of the disclosure; and

FIG. 4 is a flow diagram illustrating another exemplary method of operating an automated vehicle wash or lubrication system for prepaid plans in accordance the disclosure.

### DETAILED DESCRIPTION

The present disclosure provides a system and methodology by which the above mentioned problems and shortcomings may be minimized or overcome. Systems and methods are presented for providing user selectable car wash services or vehicle lube services in association with a prepaid customer account that allows multiple car washes and/or lubes in a given time period, or a selected number of prepaid wash/lube services with no temporal restrictions, without transactional payments being required. While described herein in the context of exemplary car wash systems, the various aspects of the disclosure also find utility in association with the provision of lube services.

The customer in one aspect may enroll in a payment program or account that allows prepayment by credit card for a fixed number or an unlimited number of car washes for a specific vehicle in a given time period, such as in a month, a calendar quarter, or other desired regular interval. The account is established using the customer's credit card information as well as customer selected car wash or lube services, and the system automatically charges the credit card at some charging period or interval. In another aspect, a prepaid customer account can be established, with the customer instead paying for a selected number of wash or lube services, and the customer's credit card is charged to replenish the account once a given number of wash/lube services have been provided. In a related implementation, such fixed unit prepaid accounts may also be managed by the system to implement maximum time periods in which the units must be used, after which the remaining unused units will be expired, and the customer's credit card with be charged to replenish the account. The customer account information is securely stored using a high level of encryption in a prepaid account database or other unitary or distributed data store, where the account can specify user selected car wash services that will be provided each time the vehicle is taken to one of the participating sites, and the user can optionally ‘upgrade’ during a given visit, for instance, by payment of an additional fee or by authorizing charging of the upgrade fee to the customer's credit card.

For regular charging-type accounts, the system allows the credit card to be automatically charged on the same day of each charging interval while the account remains active, thereby allowing the customer to receive car wash services without attending to payment transactions each time the vehicle is washed. The charging date in the interval can be aligned with the anniversary date of the establishment of the account, or can be at any other day within the defined charging time period. The accounts, moreover, may apply to a single car wash site, or to a plurality of sites, such as a group of sites operated by a single gas station chain, etc. This allows car wash operators to offer the advantages of customer-selectable prepaid car wash services and interval charging without having to devote extensive employee work hours to manually charge the credit cards each month or other period.

In addition, the system can be configured to charge the credit card on a specific day in the charging interval, with the initial charge being optionally pro-rated to accommodate fractional portions of the initial charging interval from the time the account is established to the first charging day. Similarly, the system can provide pro-rated credits to the customer credit card if the customer terminates the account on a day other than the charging day.

The system allows operators of car washes and lubrication stations to offer additional services as promotions or on a regular basis, for example, with the account being configured to allow one or more ancillary service during at least one of the predefined time periods or other specified time interval, such as a complimentary detailing service in the month of June, or offering a complimentary tire rotation once a quarter if the customer brings the designated vehicle to the lubrication station during the predefined time period. For instance, a monthly prepaid plan may be offered that includes a complimentary credit for a quarterly quick lube, which if unused in a 90 day period, will be forfeited. The ancillary service(s) may be provided on a provisional basis, such that if the vehicle is not brought to the car wash or lubrication station for the ancillary service during the predefined time period, the offer is revoked. Similarly, the regularly charged accounts that specify a maximum number of prepaid services per predefined period (e.g., 6 washes/quarter, 2 washes/month, etc.) may be administered by the system to either allow unused units to be carried forward, or to expire these if unused in a specified time period.

The system can also accommodate different site configurations with the charging component operating at one or more sites within a multi-site chain. In such embodiments, the customer can obtain the prepaid services at any site in the chain, or the system may be configured to specify a subset of the chain sites at which the prepaid accounts may be used. The charging site may be the site at which the customer originated the account, or may be the site most frequently visited, or most recently visited for car wash or lube services, or the site that charges the customer's credit card may be set by the operator of a multi-site chain according to any other criteria. Other implementations are possible in which the charging component is located in a central location or a number of locations that are not associated with a specific car wash or lube site.

In various embodiments, moreover, the system may be configured to charge the credit cards for all accounts on a given day in each charging interval, or the charges may be distributed among two or more days according to any suitable temporal distribution criteria.

The charging interval, moreover, need not be strictly periodic. For instance, since the calendar months do not all include the same number of days, even a monthly charging interval is not strictly periodic, although the system may indeed be configured to charge the customer's credit card on a strictly periodic basis. Furthermore, all accounts in the system need not be charged according to the same interval, for example, where the system can accommodate customer's needs by providing for monthly accounts as well as quarterly accounts.

In exemplary implementations, the customer is provided with a single tag for each account, which is installed on the selected customer vehicle. The tags can be barcoded for visual reading using barcode reader technology, or may include radio frequency identification (RFID) components to allow reading of a preprogrammed code via RF communications, or may include magnetically encoded components, or other identification tag types and forms may be employed. In addition, the tag is preferably specific to one vehicle only, and is accordingly constructed so as to be rendered inoperable if attempts are made to remove the tag from the vehicle. In other possible embodiments, the tag can be a magnetic striped card which need not be affixed to a given vehicle. For instance, such a tag can be coded with data indicating the customer prepaid account that specifies a fixed number of wash/lube services, and the customer can use these with any vehicle, with the credit card being charged when the remaining prepaid units reaches zero or some other predetermined number.

The site systems include tag readers, such as handheld (attendant operated) or fixed barcode, magnetic, or RFID readers configured to read the code from the tag mounted on the customer's vehicle, such as on the windshield, on a bumper, or elsewhere. In certain fully automated implementations, the customer may not need to interact with any attendants, and need not even roll down the window for interacting with a user interface, with the system reading and recognizing the vehicle tag and allowing the vehicle to enter the car wash tunnel.

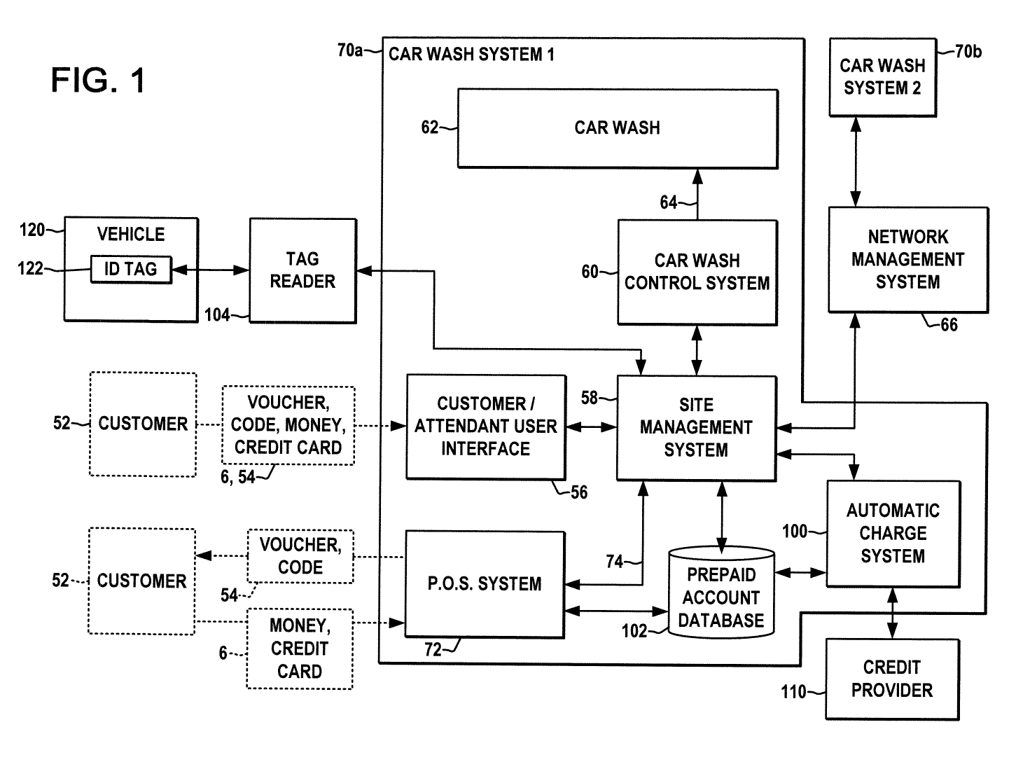

FIG. 1 illustrates an exemplary car wash chain including a first car wash system 70a and a second carwash system 70b, in which the first system 70a includes an automatic charge system 100 and a prepaid account data store 102 for managing prepaid accounts in accordance with one or more aspects of the disclosure. In this embodiment, the systems 70a and 70b include various components as generally illustrated and described in U.S. Pat. No. 6,402,030, assigned to DRB Systems, Inc. of Uniontown, Ohio, the entirety of which patent is hereby incorporated by reference as if fully set forth herein. The individual car wash system components and the elements of multi-site systems may be constructed using any suitable forms of hardware, software, firmware, logic, servers, or combinations thereof, of which individual components may be implemented as unitary components, or the functionalities thereof may be implemented in distributed fashion across two or more components, and one or more of the components illustrated and described herein may be integrated with one another.

The exemplary car wash system 70a includes contemporary means for obtaining vehicle wash services, including a point of sale (POS) system 72 at which a customer 52 may purchase a single car wash by paying money or submitting a credit card 52 in exchange for a code or a coded voucher 54. Alternatively, the customer can submit money or a credit card to a wash attendant/customer user interface 56 located near the entrance to the car wash tunnel 62, or the user may simply enter a previously purchased voucher code 54 into the interface to obtain selected car wash services, where the user interface 56 will then allow the customer's vehicle to enter the car wash tunnel 62.

In accordance with several aspects of the present disclosure, a tag reader 104 is operatively associated with the car wash system 70a to read an ID tag 122 mounted to the customer's vehicle 120, where the tag 122 can be an RFID tag, a barcode label, a magnetic encoded strip or other readable media that preferably is rendered inoperable upon removal or attempted removal from the vehicle 120. The tag 122 is encoded with data identifying the prepaid customer account and is preferably affixed to the vehicle 120 when the customer establishes an account with the operator of the system 70a, where the account may be established through an internet connection to the system 70a, or through interaction with an attendant at the POS system 72 or other suitable means. In operation, once the prepaid account is setup and the tag 122 is mounted to the vehicle 120, the user can simply drive up to the reader 104, whether permanently mounted or whether a portable reader operated by a site attendant, and be allowed to proceed to the carwash tunnel 62, or into a lube station in a lube site implementation. In addition, the customer may specify when creating the account, those wash or lube services they desire for each visit to the site. Thus, while one customer may desire only a basic wash at each visit, another customer account may specify premium services, whereby the specific options and services provided are user-selected on an account-by-account basis.

The exemplary carwash system 70a further includes a site management system 58, such as one or more servers that is/are operatively coupled with the tag reader 104, a car wash control system 60, the POS system 72, the automatic charge system 100 and the account data store 102. The site management system 58 is communicatively coupled with the car wash control system 60 which operates the car wash tunnel 62 in a controlled fashion via one or more control signals 64 according to information provided by the site management system 58. The site management system 58 communicates with a network management system 66 via a continuous link or intermittent communication links, for example, via the Internet on a periodic and/or as-needed basis to transfer information between the systems 58 and 66, where the network management system 66 also provides communicative interfacing to the second car wash system 70b at a different physical site.

The customer creates an account with the operator of the system 70a to receive a fixed number or an unlimited number of car washes for a specific vehicle in a given time period, such as in a month, a calendar quarter, or other desired period, and the user determines which specific car wash services are to be provided at each visit. Alternatively, the customer account can be for a fixed number of services, with the number of prepaid services, the service particulars, and the credit card information being associated with the customer account number. The site management system 58 and the automatic charge system 100 manage the prepaid account information in the database 102 including the customer's credit card information, selected wash services, any limits on the number of washes per charging interval, selected charging interval and day, number of prepaid services, etc. The charging system 100 then interfaces with the customer's credit provider 1 10 at some account-specific charging period or interval (or upon the number of prepaid service units reaching a preset threshold value) to charge the customer's credit card for the appropriate amount, including any upgrade or excess visit fees incurred by the customer during the previous interval.

For regular charging interval-type accounts, the account management by the charge system 100 and the data store 102 may further provide for allowing a customer a pre-determined number of car wash visits in the charging interval, after which the user may receive additional washes by either paying on-site for each additional transaction, or the customer may be notified that the limit has been exceeded and be given the option to proceed thru the wash tunnel 62 with the transaction being charged to the customer's credit card at the regular charging time.

The customer account information is stored in the prepaid account database 102, which may be a unitary database, or a distributed data store, and which may be replicated among several stores such as individual (replicated) account data stores at each site in the chain. The account information in the data store 102 specifies user selected car wash services that will be provided each time the vehicle 120 is taken to one of the participating sites, and the customer 52 can optionally ‘upgrade’ during a given visit, for instance, by payment of an additional fee on-site or by authorizing charging of the upgrade fee to the customer's credit card via the prepaid account.

Upon reading the vehicle ID tag 122, the tag reader 104 relays the encoded tag data to the site management system 58. The site management system 58 verifies the validity of the tag data by consulting the corresponding account information in the prepaid account data store 102, and if a valid account exists (and the user has not exceeded any limits on the number of services in a predefined period), determines the user-selected carwash services to be provided. As a default, the customer will receive the car wash services selected when the account was established with the site operator, although the customer may further specify additional services for the current visit, such as by payment of an upgrade fee at the POS station 72 or at the user interface 54. The site management system 58 provides the pre-selected and any upgrade services to the customer's vehicle 120 by conveying corresponding control information or signals to the car wash control system 60, which in turn operates the car wash tunnel 62 as the customer's vehicle 120 moves through the tunnel 62.

The site management system 58 further provides information related to the current visit to the automatic charge system 100, the account data store 102, and/or to the network management system for forwarding to systems at other sites or to a central office, whereby customer vehicle usage of the prepaid account can be tracked. Moreover, the charge system 100 may provide account information to the visited site management system 58 upon identification of a prepaid account holder's vehicle 120, such as usage history, pre-selected services, account options, special offerings, etc. so that the site management system 58 can take appropriate action for the specified customer, including notifying the vehicle operator of account limits that have been reached, notifying the customer of special offers specific to a particular time or day (e.g., promotional ancillary service offers that may be about to expire), providing appropriate control commands to the control system 60 for provision of the preselected services, etc. In this respect, the automatic charge system 100 may provide for accounts specifying a limit to the number of visits in a given month, after which the customer would be required to pay for additional washes via the POS system 72 or the user interface 56. Furthermore, the charge system 100 or other component of the visited car wash system 70a or a central office server may compile usage data for a variety of uses, such as informing customers of their usage history, enforcing usage rules such as limits to the number of visits in a given day, generating marketing reports, determining possible package discounts to offer, etc. In addition, the usage data for a given account may include indications of which site in a multi-site system is being visited by a particular customer vehicle, where the account data store 102 may be used to store and manage such gathered or derived data or such may be centrally managed with replication possibilities such that all localized (site-based) account data stores 102 are coherent.

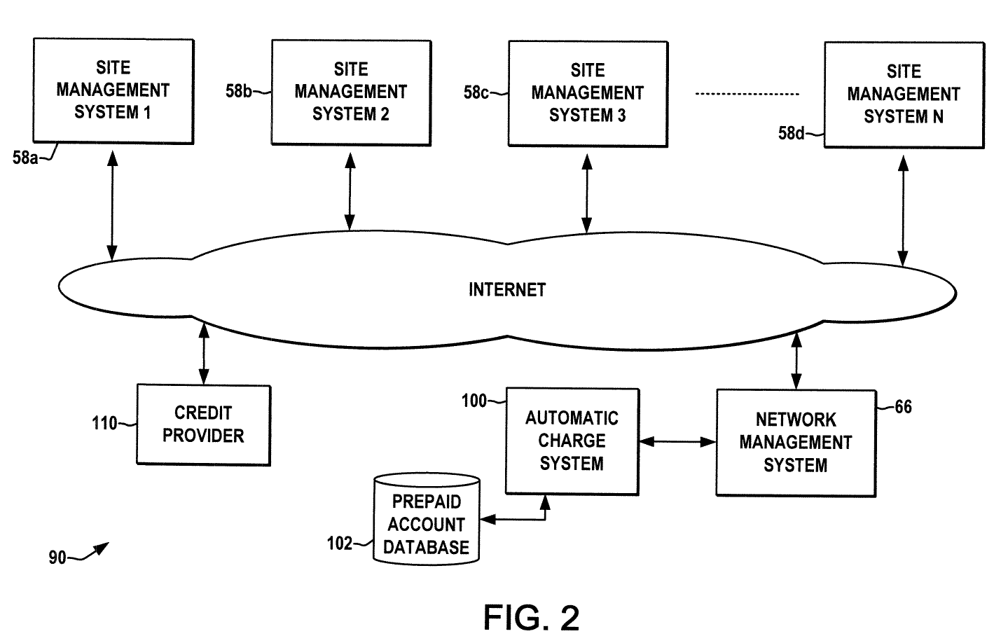

FIG. 2 illustrates another possible configuration of a multi-site car wash chain 90 in which an integer number N car wash sites are operated as a multi-site chain using network connections such as the Internet or others for exchanging data and information related to the overall system 90 and the prepaid accounts described herein, wherein other types and forms of network interconnections are contemplated as falling within the scope of the present disclosure. The system 90 comprises a network management system 66 and a plurality of site management systems 58a, 58b, 58c, 58d that communicate with the network management system 66 via the Internet, where the individual site management systems 58 may be each located remotely from one another, as well as from the network management system 66, or the network management system 66 may be located at one of the sites.

In the example of FIG. 2, the network management system 66, the automatic charge system 100, and the account data store 102 are located in a central management office remote from each of the sites and associated site management systems 58, although other implementations are possible in which one or more of these components are located at a car wash site. Alternatively, two or more wash sites may include an account charge system 100 and account database 102, where usage data and other account information may be replicated among the charge systems 100 and data stores 102 such that the account information and usage data is coherent among all the sites and the central office in a multi-site system 90. In such implementations, the operator of a given chain may selectively designate which site-based automatic charge system 100 is to perform the credit card charging for a given account. In this regard, an operator may desire that the charging site be the site at which the customer originated the account, or the site most frequently visited, or the most recently visited site, or the charging site may be selected according to any other criteria (such as centralized charging).

The system 90 and the automatic charge system 100 thereof provides for automatic charging of the customer's credit card by communication with the customer's credit provider 110 on the same day of each charging interval while the account remains active, such as on the first or last day of a monthly interval, or on any other operator/customer selected day of the interval, where the interval can be customer/operator selected and thereafter modified, and where the interval and charging day can be different for different accounts. For instance, the charging day in the interval may be aligned with the anniversary date of the establishment of the account, or can be at any other day within the defined charging time period.

The accounts, moreover, may apply to a single car wash site 70, or to a plurality of sites, such as a group of sites in a multi-site system 90 operated by a single gas station chain, etc., as shown in FIG. 2. This allows car wash operators to offer the advantages of customer-selectable prepaid car wash services and interval charging without having to devote extensive employee work hours to manually charge the credit cards each month or other period. This system, moreover, advantageously allows the customer 52 to receive car wash services at any one of the sites participating in the prepaid account program without requiring the customer to provide payment for each individual transaction.

In addition, the charging system 100 can be configured to charge the credit card on a specific day in the charging interval, with the initial charge being optionally pro-rated to accommodate fractional portions of the initial charging interval from the time the account is established to the first charging day. Similarly, the system 100 is operative to provide pro-rated credits to the customer credit card if the customer terminates the account on a day other than the charging day. In various embodiments, moreover, the system 100 may be configured to charge the credit cards for all accounts on a given day in each charging interval, or the charges may be distributed among two or more days according to any suitable temporal distribution criteria. In addition, the charging interval need not be strictly periodic, and the charging interval and charging days may be different for different accounts.

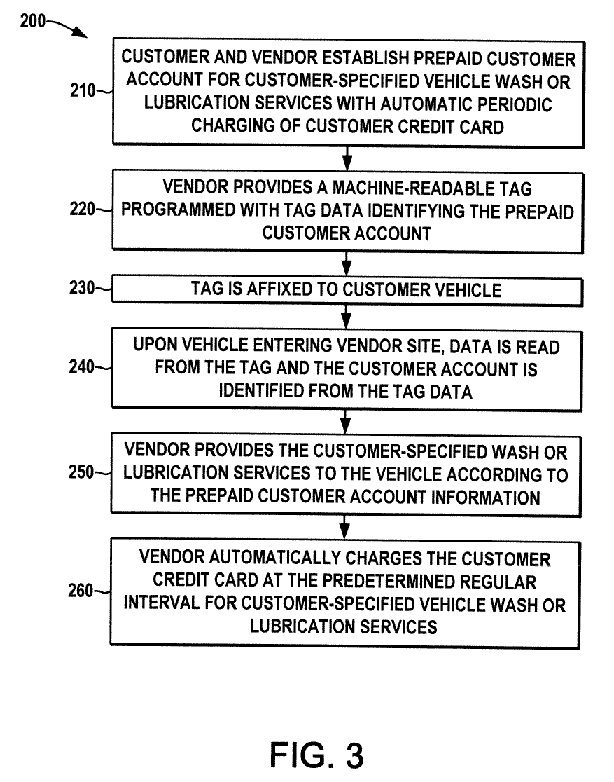

FIG. 3 illustrates an exemplary method 200 in accordance with one or more aspects of the disclosure. While the exemplary method 200 is illustrated and described below as a series of acts or events, it will be appreciated that the present disclosure is not limited by the illustrated ordering of such acts or events. For example, some acts may occur in different orders and/or concurrently with other acts or events apart from those illustrated and/or described herein, in accordance with the disclosure. In addition, not all illustrated steps may be required to implement a methodology in accordance with the present disclosure. Moreover, the methods of the disclosure may be carried out in conjunction with various systems and apparatus illustrated and described herein, as well as in association with other systems not illustrated.

At 210, the customer and the car wash or vehicle lube system vendor establish a prepaid customer account. The account comprises account information that specifies the customer's credit card, as well as one of more car wash services or vehicle lubrication services that the customer desires to be provided, such as a full service wash, a basic wash, a full service oil change and lube service, etc., where the customer can choose the desired services and may optionally specify that the vendor will provide the chosen services as many times as the vehicle is brought to the vendor system (e.g., possibly with the stipulation that only one visit per day is covered by the prepaid account), or the customer may select a fixed number of visits in a given time period. The time periods covered by the prepaid account may be selected, such as monthly, quarterly, seasonally, etc. Moreover, the account information may indicate the regular interval at which the customer credit card will be automatically charged, where the predefined time periods in which the services are provided and the regular charging interval may be the same (e.g., monthly), or may be different. In this regard, the customer may desire that the number of car washes be limited to a fixed number per calendar quarter, but may select to have their credit card charged on a monthly basis. Moreover, the customer may decide to have the credit card charged on the first of each month, on the 15^{th} day of each month, or any other preselected date within the selected charging interval.

The vendor programs a tag at 220, such as an RFID tag, a barcoded tag, etc., with tag data that indicates the prepaid customer account, and provides the programmed tag to the customer. The vendor may optionally install the tag on the customer vehicle, or the customer may do this at 230. The tag may be affixed to any suitable location on the specified vehicle covered by the account such that the tag data can be read by a fixed or attendant operated tag reader. In one example, the tag may be affixed to the vehicle windshield, or may alternatively be mounted to the vehicle bumper, or license plate or other easily accessible location. The tag is preferably of a form that will be rendered inoperable if removed from the vehicle, so as to inhibit the use of the tag with more than one vehicle. In certain implementations, the tag may be an RFID tag programmed with the tag data by the vendor and installed in a location on the vehicle from which the tag data can be read at 240 by a handheld or fixed tag reader located near the entrance to the vendor site. Other types of coded tags, such as visible barcodes, or magnetically programmable and readable media can be used for the tag, which can be affixed to the vehicle and which can be read using suitable corresponding tag readers operatively coupled with the vendor site management system.

When the tag data is read at 240, the customer account is automatically identified therefrom, such as by the site management system 58 querying the prepaid customer account database 102 in the system of FIG. 1 above to retrieve the account information for the account associate with the vehicle. The customer-specified wash or lube services are automatically provided to the vehicle at 250 according to the account information, where the customer may be allowed to authorize additional services and pay for such on-site. At 260, the vendor automatically charges the customer credit card at the predetermined regular interval for the services provided (or made available even if not used by the customer). In one embodiment, the credit card charging at 260 can include an optional grace period, where if the consumer credit card access on the first try is unsuccessful, the system will retry after a programmable grace period, for example, such as five business days, a certain number of hours, etc. Moreover, the system may be operative to automatically deactivate the customer account if the credit card charge attempts fail a certain number of times in order to prevent credit abuse, after which the customer may contact the vendor to reestablish or reactivate the account.

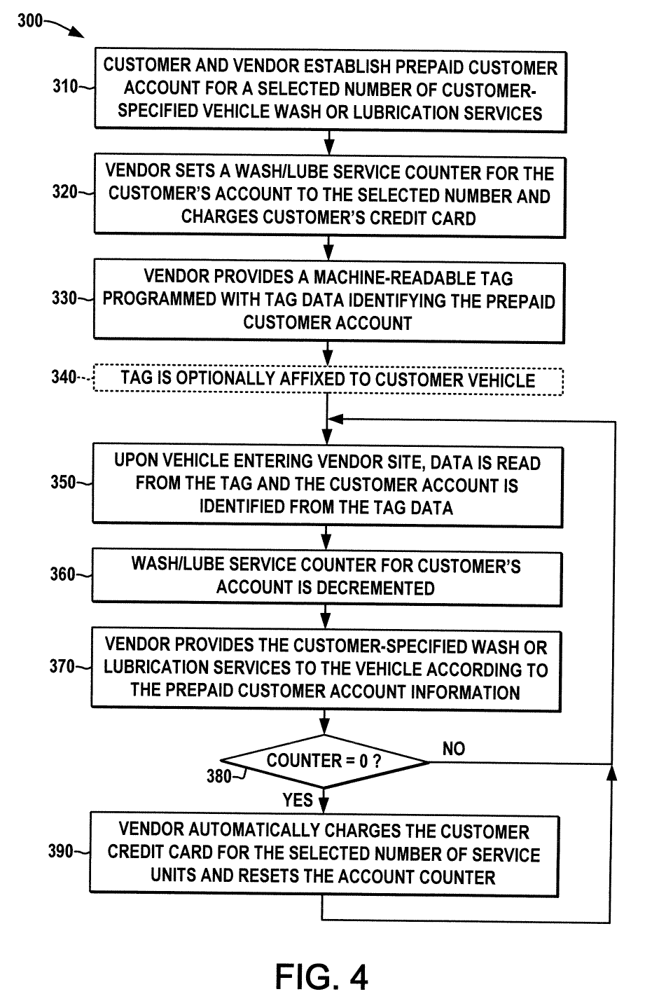

FIG. 4 illustrates another exemplary method 300 for providing prepaid wash or lube services for prepaid plans that specify a fixed number of services before recharging the customer's credit card in accordance with further aspects of the present disclosure. The method 300 begins at 310 is establishment of a customer account by the customer and the site vendor/operator. The customer account in this case specifies a customer credit card, customer selected car wash or lubrication services to be provided, and a selected number of wash or lubrication services, which may be fixed by the operator, or may be customer-selectable. In one implementation, the vendor establishes a counter at 320 (e.g., maintained in the prepaid account database in FIG. 102) that is associated with the customer account, and sets the counter value to indicated the selected number of wash/lube services. At 320, the vendor programs a tag (e.g., RFID, magnetic, barcode, etc.) with tag data indicative of the prepaid customer account, and provides this to the customer. The programmed tag may optionally be affixed to a specific customer vehicle at 340, although not a strict requirement of the present disclosure. In one example, a magnetically encoded card/tag is provided to the customer, with the customer's vehicle license plate number printed on the tag, and when presented at the site, an operator can verify that the customer's vehicle is indeed the one being serviced.

When the customer brings a vehicle to the vendor site at 350, the tag data is read from the tag (whether affixed to the vehicle or separate), and the site system automatically identifies the prepaid customer account based at least partially on the tag data. At 360, the counter associated with the customer account is decremented and the wash/lube services specified in the account information are provided (with optional upgrading as described above) at 370. A determination is made at 380 as to whether is 5 the account counter has reached a given value, such as zero in the illustrated example. Other implementations are possible, in which the counter value is compared with another given value that is less than or equal to the originally selected number of prepaid service units provided with the account. If the limit has not yet been reached (NO at 380), the process 300 returns to await the customer's next visit at 350 as described above. Otherwise (YES at 380), the system automatically charges the customer credit card at 390 to replenish the account (e.g., charging a fee for the selected number of service units), and the account counter is reset to the selected number.

The above examples are merely illustrative of several possible embodiments of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

What is claimed is:

1. A method for providing prepaid vehicle wash or lubrication services in an automated car wash or lubrication station, the method comprising:
establishing a prepaid customer account for car wash or lubrication services to be provided to a customer vehicle in predefined time periods, the account specifying a customer credit card as well as customer selected carwash or lubrication services to be provided to the customer vehicle;
providing a tag comprising tag data indicative of the prepaid customer account;
affixing the tag to a specific customer vehicle;
reading tag data from the tag when the specific customer vehicle is brought to the car wash or lubrication station;
automatically identifying the prepaid customer account based at least partially on the tag data;
providing the customer selected car wash or lubrication services to the specific customer vehicle according to the customer account; and
automatically charging the customer credit card at a regular interval for services provided under the prepaid customer account during the predefined time periods.

2. The method of claim 1, wherein establishing the prepaid customer account further comprises specifying either an unlimited number or a fixed number of car washes or vehicle lubrication services to be provided to the specific customer vehicle during the predefined time periods.

3. The method of claim 1, wherein establishing the prepaid customer account further comprises specifying the regular interval at which the customer credit card is charged.

4. The method of claim 1, wherein providing the tag comprises programming an RFID tag with tag data indicative of the prepaid customer account.

5. The method of claim 1, wherein providing the tag comprises providing a barcode tag with tag data indicative of the prepaid customer account.

6. The method of claim 1, wherein providing the tag comprises programming a magnetic stripe on a tag with tag data indicative of the prepaid customer account.

7. The method of claim 1, wherein providing the tag comprises providing a tag that will be inoperable if removed from the specified customer vehicle.

8. The method of claim 1, wherein automatically charging the customer credit card at a regular interval comprises charging the customer credit card on an adjustable date within the predefined time periods.

9. The method of claim 1, further comprising pro-rating the customer account for the time from establishment of the account until the next date for automatic charging, and charging the customer credit card for the prorated amount upon establishment of the account.

10. The method of claim 1, further comprising:
offering at least one ancillary service during at least one of the predefined time periods; and
selectively providing the at least one ancillary service to the specific customer vehicle according to the customer account if the specific customer vehicle is brought to the car wash or lubrication station for the at least one ancillary service during the at least one predefined time period.

11. The method of claim 10, further comprising refraining from providing the at least one ancillary service to the specific customer vehicle if the specific customer vehicle is not brought to the car wash or lubrication station for the at least one ancillary service during the at least one predefined time period.

12. The method of claim 1, wherein automatically charging the customer credit card at the regular interval further includes providing an optional grace period if the customer credit card fails on a first try, retrying the credit card after expiration of a predetermined grace period.

13. The method of claim 12, wherein automatically charging the customer credit card at the regular interval further includes automatically deactivating the customer account to prevent abuse if the customer credit card fails on an nth try, with n being an integer greater than 1.

14. A method for providing prepaid vehicle wash or lubrication services in an automated car wash or lubrication station, the method comprising:
establishing a prepaid customer account for car wash or lubrication services to be provided to a customer, the account specifying a customer credit card, customer selected car wash or lubrication services to be provided, and a selected number of wash or lubrication services;
providing a tag comprising tag data indicative of the prepaid customer account;
reading tag data from the tag when the tag is brought to the car wash or lubrication station;
automatically identifying the prepaid customer account based at least partially on the tag data;
providing the customer selected carwash or lubrication services to the customer vehicle according to the customer account; and
automatically charging the customer credit card to replenish the customer account once a given number of the customer selected car wash or lubrication services have been provided under the prepaid customer account, the given number being less than or equal to the selected number.

15. The method of claim 14, further comprising affixing the tag to a specific customer vehicle.

16. The method of claim 15, wherein providing the tag comprises programming an RFID tag with tag data indicative of the prepaid customer account or providing a barcode tag with tag data indicative of the prepaid customer account.

17. The method of claim 15, wherein providing the tag comprises providing a tag that will be inoperable if removed from the specified customer vehicle.

18. The method of claim 14, wherein providing the tag comprises programming a magnetic stripe on a tag with tag data indicative of the prepaid customer account.

19. The method of claim 14, wherein the selected and given numbers are the same and the customer credit card is automatically charged to replenish the customer account once all the prepaid services have been provided.

20. The method of claim 14, wherein automatically charging the customer credit card at the regular interval further includes providing an optional grace period if the customer credit card fails on a first try, retrying the credit card after expiration of a predetermined grace period.

21. The method of claim 20, wherein automatically charging the customer credit card at the regular interval further includes automatically deactivating the customer account to prevent abuse if the customer credit card fails on an nth try, with n being an integer greater than 1.

22. An automated vehicle wash or lubrication system comprising:
a car wash tunnel or lubrication station;
a prepaid account data store including prepaid customer account information for a customer account, the account information comprising a customer credit card and customer selected car wash or lubrication services to be provided to a customer vehicle during the predefined time periods;
a tag reader operative to read tag data from a tag mounted on the customer vehicle at the car wash tunnel or lubrication station;
a site management system operatively coupled with the data store and the tag reader to identify the customer account from the tag data;
a car wash or lubrication station control system operated by the site management system to provide the customer selected car wash or lubrication services to the customer vehicle according to the customer account information; and
an automatic charge system operatively coupled with the prepaid account data store to automatically charge the customer credit card at a regular interval.

23. The system of claim 22, wherein the car wash or lubrication station is in a multi-site chain including a plurality sites, each site including:
a car wash tunnel or lubrication station,
a tag reader operative to read tag data from a tag mounted on the customer vehicle at the car wash tunnel or lubrication station,
a site management system operatively coupled with the data store and the tag reader to identify the customer account from the tag data, and
a car wash or lubrication station control system operated by the site management system to provide the customer selected car wash or lubrication services to the customer vehicle according to the customer account information.

24. system of claim 22, wherein the tag reader, the car wash or lubrication station control system, and the automatic charge system are operatively coupled with a point of sale (POS) system at the site.

25. An automated vehicle wash or lubrication system comprising:
a car wash tunnel or lubrication station;
a prepaid account data store including prepaid customer account information for a customer account, the account information comprising a customer credit card, customer selected car wash or lubrication services to be provided, and a selected number of wash or lubrication services
a tag reader operative to read tag data from a tag mounted on the customer vehicle at the car wash tunnel or lubrication station;
a site management system operatively coupled with the data store and the tag reader to identify the customer account from the tag data;
a car wash or lubrication station control system operated by the site management system to provide the customer selected car wash or lubrication services to the customer vehicle according to the customer account information; and
an automatic charge system operatively coupled with the prepaid account data store to automatically charge the customer credit card once a given number of the customer selected car wash or lubrication services have been provided under the prepaid customer account, the given number being less than or equal to the selected number.

26. The system of claim 25, wherein the car wash or lubrication station is in a multi-site chain including a plurality sites, each site including:
a car wash tunnel or lubrication station,
a tag reader operative to read tag data from a tag mounted on the customer vehicle at the car wash tunnel or lubrication station,
a site management system operatively coupled with the data store and the tag reader to identify the customer account from the tag data, and
a car wash or lubrication station control system operated by the site management system to provide the customer selected car wash or lubrication services to the customer vehicle according to the customer account information; and
wherein the automatic charge system is operatively coupled with the site management system of each site in the chain and with the prepaid account data store to automatically charge the customer credit card once the given number of the customer selected car wash or lubrication services have been provided at any of the sites in the chain under the prepaid customer account.

27. system of claim 25, wherein the tag reader, the car wash or lubrication station control system, and the automatic charge system are operatively coupled with a point of sale (POS) system at the site.

28. A method for operating an automated vehicle wash or lubrication system, the method comprising:
providing a prepaid account data store including prepaid customer account information for a customer account, the account information comprising a customer credit card and customer selected car wash or lubrication services to be provided to a customer vehicle during predefined time periods;
reading tag data from a tag mounted on a customer vehicle when the customer vehicle is brought to the car wash or lubrication station;
automatically identifying a prepaid customer account based at least partially on the tag data using the prepaid account data store;
automatically providing the customer selected car wash or lubrication services to the customer vehicle according to the customer account information; and
automatically charging the customer credit card at a regular interval for services provided under the prepaid customer account during the predefined time periods.

29. The method of claim 28, wherein automatically providing the customer selected car wash or lubrication services comprises selectively providing an unlimited number or a fixed number of car washes or vehicle lubrication services to the customer vehicle during the predefined time periods according to the customer account information.

30. The method of claim 28, wherein the car wash or lubrication station is in a multi-site chain including a plurality sites, and wherein the customer credit card is automatically charged at the regular interval for services provided under the prepaid customer account at any one of the sites in the chain during the predefined time periods.

31. A method for operating an automated vehicle wash or lubrication system, the method comprising:
providing a prepaid account data store including prepaid customer account information for a customer account, the account specifying a customer credit card, customer selected car wash or lubrication services to be provided, and a selected number of wash or lubrication services;
reading tag data from a tag mounted on a customer vehicle when the customer vehicle is brought to the car wash or lubrication station;
automatically identifying a prepaid customer account based at least partially on the tag data using the prepaid account data store;
automatically providing the customer selected carwash or lubrication services to the customer vehicle according to the customer account information; and
automatically charging the customer credit card once a given number of the customer selected car wash or lubrication services have been provided under the prepaid customer account, the given number being less than or equal to the selected number.

32. The method of claim 31, wherein the car wash or lubrication station is in a multi-site chain including a plurality sites, and wherein the customer credit card is automatically charged once the given number of the customer selected car wash or lubrication services have been provided at any of the sites in the chain under the prepaid customer account.

33. A computer-readable medium having computer-executable instructions for performing the steps of:
providing a prepaid account data store including prepaid customer account information for a customer account, the account information comprising a customer credit card and customer selected car wash or lubrication services to be provided to a customer vehicle during predefined time periods;
reading tag data from a tag mounted on a customer vehicle when the customer vehicle is brought to the car wash or lubrication station;
automatically identifying a prepaid customer account based at least partially on the tag data using the prepaid account data store;
automatically providing the customer selected carwash or lubrication services to the customer vehicle according to the customer account information; and
automatically charging the customer credit card at a regular interval for services provided under the prepaid customer account during the predefined time periods.

34. A computer-readable medium having computer-executable instructions for performing the steps of:
providing a prepaid account data store including prepaid customer account information for a customer account, the account specifying a customer credit card, customer selected car wash or lubrication services to be provided, and a selected number of wash or lubrication services;
reading tag data from a tag mounted on a customer vehicle when the customer vehicle is brought to the car wash or lubrication station;
automatically identifying a prepaid customer account based at least partially on the tag data using the prepaid account data store;
automatically providing the customer selected carwash or lubrication services to the customer vehicle according to the customer account information; and
automatically charging the customer credit card once a given number of the customer selected car wash or lubrication services have been provided under the prepaid customer account, the given number being less than or equal to the selected number.
